(19) United States
(12) Patent Application Publication
(10) Pub. No.: US 2022/0230291 A1
(43) Pub. Date: Jul. 21, 2022

(54) METHOD FOR DETECTING DEFECTS IN IMAGES, APPARATUS APPLYING METHOD, AND NON-TRANSITORY COMPUTER-READABLE STORAGE MEDIUM APPLYING METHOD

(71) Applicant: HON HAI PRECISION INDUSTRY CO., LTD., New Taipei (TW)

(72) Inventors: WEI-CHUN WANG, New Taipei (TW); CHIN-PIN KUO, New Taipei (TW)

(21) Appl. No.: 17/573,836

(22) Filed: Jan. 12, 2022

(30) Foreign Application Priority Data
Jan. 18, 2021 (CN) 202110062706.0

(51) Int. Cl. G06T 7/00; G06V 10/776; G06V 10/774

(52) U.S. Cl. CPC G06T 7/001; G06V 10/776; G06T 2207/20084; G06T 2207/20081; G06V 10/774

(57) ABSTRACT

A method for detecting defects in products revealed by images of the products inputs images of the flaw-free products into an autoencoder for model training to obtain reconstructed images. The images are further processed to obtain target images. A group of testing errors are obtained by comparing the reconstructed images and the target images. An error threshold is selected from the group of the testing errors according to a specified rule. A to-be-analyzed image is inputted for obtaining a candidate be-analyzed reconstructed image, a candidate be-analyzed target image, and a potential be-analyzed error between the candidate be-analyzed reconstructed image and the candidate be-analyzed target image. A result of the to-be-analyzed image confirms defects existing or defects not existing according to the potential be-analyzed error and the error threshold. A defect detection apparatus, an electronic device, and a non-transitory computer-readable storage medium applying the method are also disclosed.

### FIELD

The subject matter herein generally relates to manufacturing, and imaging control for detection of defects.

### BACKGROUND

Detection of defects in products is an important part in an industrial manufacture process, such as defects in textile products, and defects in printed circuit boards. A manual detection method is very labor-intensive and time-consuming, and accuracy of detection relies on an experience and visual acuity of inspectors, thus a detection accuracy is not optimal.

Thus, there is room for improvement in the art.

### BRIEF DESCRIPTION OF THE FIGURES

Implementations of the present disclosure will now be described, by way of example only, with reference to the attached figures.

FIG. 1 is a flowchart illustrating an embodiment of a method for detecting defects by imaging.

FIG. 2 is a detailed flowchart illustrating an embodiment of block S1 in the method of FIG. 1.

FIG. 3 is a detailed flowchart illustrating an embodiment of block S2 in the method of FIG. 1.

FIG. 4 is a detailed flowchart illustrating an embodiment of block S3 in the method of FIG. 1.

FIG. 5 is a diagram illustrating an embodiment of a defect detection apparatus.

FIG. 6 is a diagram illustrating an embodiment of an electronic device applying the method of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

In general, the word “module,” as used herein, refers to logic embodied in hardware or firmware, or to a collection of software instructions, written in a programming language, for example, Java, C, or assembly. One or more software instructions in the modules may be embedded in firmware, such as an EPROM, magnetic, or optical drives. It will be appreciated that modules may comprise connected logic units, such as gates and flip-flops, and may comprise programmable units, such as programmable gate arrays or processors, such as a CPU. The modules described herein may be implemented as either software and/or hardware modules and may be stored in any type of computer-readable medium or other computer storage systems. The term “comprising” means “including, but not necessarily limited to”; it specifically indicates open-ended inclusion or membership in a so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one.”

The present disclosure provides a method for detecting product defects in images of the products.

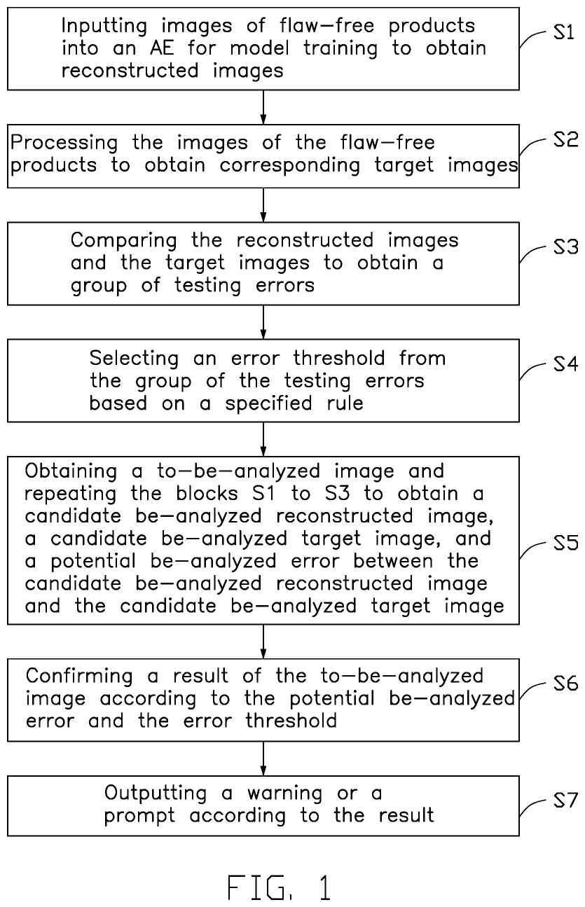

FIG. 1 shows a method, the method may comprise at least the following steps, which also may be re-ordered:

In block S1, inputting images of flaw-free products into an autoencoder (AE) for model training to obtain reconstructed images.

In one embodiment, the AE is part of an artificial neural network (ANNs) category in a semi-supervised machine learning and unsupervised machine learning environment. Representation learning is a function of the AE by using input information as learning targets.

In one embodiment, the AE can be a contractive AE, a regularized AE, or other types of AE, not being limited.

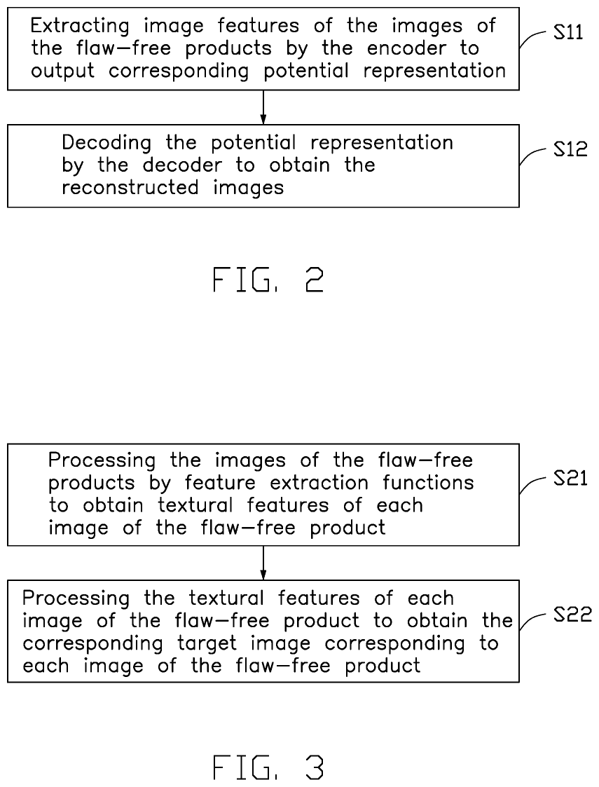

In one embodiment, the AE includes an encoder and a decoder. FIG. 2 illustrates a detail flowchart of the block S1, a step in the method. The block S1 further includes these sub-steps.

In block S11, extracting image features of the images of the flaw-free products by the encoder to output corresponding potential representation.

In block S12, decoding the potential representation by the decoder to obtain corresponding reconstructed images.

The encoder and the decoder are parameterized software. The potential representation exhibits features extracted from images of flaw-free products, the existence and identification of such features having been learned by the encoder based on the images of the flaw-free products. The potential representation represents textural features of the images of the flaw-free products.

In block S2, processing the images of the flaw-free products to obtain target images. FIG. 3 illustrates a detail flowchart of the block S2. The block S2 further includes the following sub-steps.

In block S21, processing the images of the flaw-free products by feature extraction functions to obtain textural features of each image of the flaw-free product.

In block S22, processing the textural features of each image of the flaw-free product to obtain the corresponding target image corresponding to each image of the flaw-free product.

In one embodiment, the feature extraction functions, in block S21 and block S22, are a Gabor function and a gray-level co-occurrence matrix (GLCM) function. The textural feature is a GLCM of the image of the flaw-free product.

It is understood that, the Gabor function is a Windowed Fourier Transform function. The Gabor function can extract related features from different scales or different directions in an image field. The GLCM is a matrix function related to pixel distance and angles. The GLCM reflects integrated information of the image in direction, interval, rangeability, and speed, by computing grayscale correlation between two points with a specified distance along a specified direction in the image.

A texture is formed by perennial gray existing in spatial locality, thus there is grayscale relation between two pixels with the specified distance in the image space, which is the grayscale correlation. The GLCM is a regular method for describing the texture by statistical spatial correlation of the gray level.

Thus, in the embodiment, in the block S2, the image of the flaw-free product is processed by the Gabor function to obtain corresponding complex signal, and an imaginary component of the complex signal is processed by the GLCM function to obtain a corresponding GLCM, which serves as the textural feature of the image of the flaw-free product. The GLCM is reconstructed according to the gray level to obtain the corresponding target image.

It is understood that, in other embodiments, the block S2 can be implemented before the block S1, or the block S1 and the block S2 can be executed at the same time.

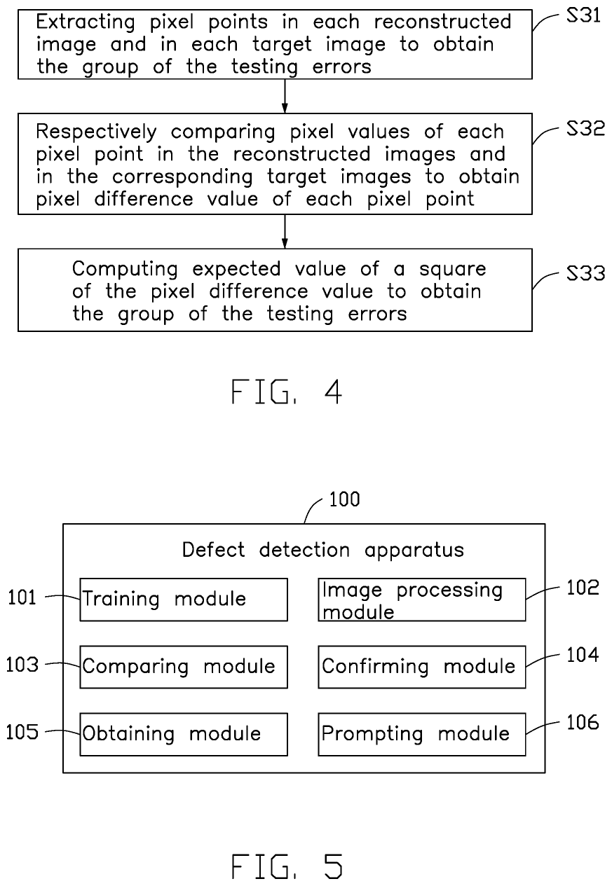

In block S3, the reconstructed images and the target images are compared to obtain a group of testing errors. FIG. 4 illustrates a detail flowchart of the block S3. The block S3 further includes the following sub-steps.

In block S31, extracting pixel points in each reconstructed image and each target image to obtain the group of the testing errors.

In block S32, respectively comparing pixel values of each pixel point in the reconstructed images and in the corresponding target images to obtain pixel difference value of each pixel point.

In block S33, computing expected value of a square of the pixel difference value to obtain the group of the testing errors.

It is understood that, in other embodiments, before the block S31, the reconstructed images and the target images are pre-processed for rendering the reconstructed images and the target images in same size and direction, which make the processes of the block S31 to the block S33 easier.

It is understood that, in one embodiment, each testing error is a mean squared error.

The type of the testing errors can be peak signal to Noise Ratio (PSNR), or structural similarity (SSIM), not being limited.

In block S4, selecting an error threshold from the group of the testing errors based on a specified rule.

In one embodiment, the specified rule is that a maximum value in the group of the testing errors is to serve as the error threshold.

In block S5, obtaining a to-be-analyzed image and repeating the blocks S1 to S3 to obtain a candidate be-analyzed reconstructed image, a candidate be-analyzed target image, and a potential be-analyzed error between the candidate be-analyzed reconstructed image and the candidate be-analyzed target image.

It is understood that, the candidate be-analyzed reconstructed image in the block S5 is acquired by a same manner as for the reconstructed image in the block S1. The candidate be-analyzed target image is acquired by a same manner of the target image in the block S2. The potential be-analyzed error is acquired by same manner as for the testing error in the block S3.

The potential be-analyzed error is a mean squared error of the candidate be-analyzed reconstructed image and the candidate be-analyzed target image.

The type of the potential be-analyzed error is the same as the type of testing error. The type of the potential be-analyzed error can be PSNR or SSIM, not being limited.

In block S6, confirming a result of the to-be-analyzed image according to the potential be-analyzed error and the error threshold.

The block S6 further includes the following steps:

When the potential be-analyzed error is less than the testing error, the result of to-be-analyzed image is taken as confirming that there is no defect revealed in the to-be-analyzed image.

When the potential be-analyzed error is larger than or equal to the testing error, the result of the to-be-test image is taken as confirming that one or more defects exist and are revealed in the to-be-analyzed image.

It is understood that, in other embodiment, the method can further include a block S7.

In block S7, outputting a warning or a prompt according to the result.

Different actions can be executed depending on the result. For example, in one embodiment, when the result is that there is one or more defect exist and are revealed in the to-be-analyzed image, the prompting information is generated, and is sent to a terminal device of a specified contact person. The specified person can be a quality control person in charge of detecting defects in the images of target objects. Thus, when the image reveals defects, the specified person is notified.

For describing the method disclosed, N images of the flaw-free products for example are inputted into the AE.

Firstly, when the N images of the flaw-free products are inputted into the AE, and labeled as image of the flaw-free product 1, image of the flaw-free product 2, . . . , and image of the flaw-free product N, and the corresponding reconstructed images are obtained, the reconstructed images are labeled as reconstructed image 1, reconstructed image 2, reconstructed image 3, . . . , and reconstructed image N. Next, the N images of the flaw-free products are processed by the Gabor function and the GLCM function to obtain the corresponding target images. The target images are labeled as target image 1, target image 2, target image 3, . . . , and target image N. The target images are respectively compared with the reconstructed images to obtain the group of the testing errors. For example, the target image 1 is compared with the reconstructed image 1 to obtain an error value, which is 0.01, serving as testing error 1. The target image 2 is compared with the reconstructed image 2 to obtain an error value, which is 0.02, serving as testing error 2. The target image 3 is compared with the reconstructed image 3 to obtain an error value, which is 0.0001, serving as testing error 3. The target image N is compared with the reconstructed image N to obtain an error value, which is 0.01, serving as testing error N. The maximum testing error is selected to serve as the error threshold. The to-be-analyzed image is obtained and inputted into the AE to obtain the candidate be-analyzed reconstructed image. The candidate be-analyzed reconstructed image is processed by the Gabor function and the GLCM function to obtain the candidate be-analyzed reconstructed image. The candidate be-analyzed reconstructed image is compared with the candidate be-analyzed target image to obtain the potential be-analyzed error. The potential be-analyzed error is compared with the error threshold. When the potential be-analyzed error is less than the error threshold, the result is taken as confirmation that there is no defect revealed in the to-be-analyzed image. When the potential be-analyzed error is larger than or equal to the error threshold, the result is taken as confirmation that is there is one or more defect exist and are revealed in the to-be-analyzed image.

In one embodiment, the AE is trained by the images of the flaw-free products, when the to-be-analyzed image with defect is inputted, the AE can further repair a part of the defect to output a reconstructed image after being repaired. Further, the specified feature extracting functions are used for processing the to-be-analyzed image (or the images of the flaw-free products) to obtain the candidate be-analyzed target image (or the target image), therefore redundant information of the to-be-analyzed image is reduced, and feature information of the to-be-analyzed image (or the image of the flaw-free product) are magnified. Thus, the potential be-analyzed error between the candidate be-analyzed reconstructed image obtained by the AE with the inputted same image and the candidate be-analyzed target image processed by the feature extracting functions needs to be within a specified range. When the potential be-analyzed error is outside the specified range, it is considered that the AE repairs a part of the at least one defect, which cause the error between the candidate be-analyzed reconstructed image and the candidate be-analyzed target to being outside the specified range. The invention confirms the error threshold by comparing the several reconstructed images and the corresponding target images. The error threshold is a maximum acceptable error while reconstructing the image of the flaw-free product. When the potential be-analyzed error between the candidate be-analyzed reconstructed image and the candidate be-analyzed target image is larger than the error threshold, there is at least one defect revealed in the to-be-analyzed image, which causes the error of the reconstructed image by the AE to be larger than the error threshold.

The to-be-analyzed image is processed by the feature extracting function for extracting textural features, and the to-be-analyzed image is reconstructed according to the textural features to obtain the candidate be-analyzed target image, thus the redundant information of the to-be-analyzed image is reduced, and the textural features of the to-be-analyzed image is magnified. An accuracy of the comparison between the candidate be-analyzed reconstructed image and the candidate be-analyzed target image is improved, so increasing detection accuracy.

Referring to FIG. 5, FIG. 5 illustrates a defect detection apparatus 100. The defect detection apparatus 100 includes a training module 101, an image processing module 102, a comparing module 103, a confirming module, and an obtaining module.

The training module 101 inputs the images of the flaw-free products into the AE for model training to obtain reconstructed images.

The image processing module 102 processes the images of the flaw-free products to obtain corresponding target images.

The comparing module 103 compares the reconstructed images and the target images to obtain a group of testing errors.

The confirming module 104 selects an error threshold from the group of the testing errors based on a specified rule.

The obtaining module 105 obtains a to-be-analyzed image, inputs the to-be-analyzed image to the training module 101 to obtain a candidate be-analyzed reconstructed image.

The image processing module 102 further processes the candidate be-analyzed target image to obtain a candidate be-analyzed target image. The comparing module 103 further compares the candidate be-analyzed reconstructed image and the candidate be-analyzed target image to obtain a potential be-analyzed error. The confirming module 104 further confirms the result of the to-be-analyzed image according to the potential be-analyzed error and the error threshold.

In other embodiments, the defect detection apparatus 100 can further include a prompting module 106. The prompting module 106 outputs a warning or a prompt according to the result. For example, in one embodiment, when the result is taken as confirming that there is one or more defect exist and are revealed in the to-be-analyzed image, the prompting module 106 outputs the prompt, and is sent to a terminal device of a specified contact person. The specified person can be a quality person in charge of detecting defects in the images of target objects. Thus, when the image with the defects, the specified person is notified.

The training module 101, the image processing module 102, the comparing module 103, the confirming module 104, the obtaining module 105, and the prompting module 106 cooperate with each other to execute the block S1 to the block S7 of the method. No more detailed description of the detail implement process of each module will described.

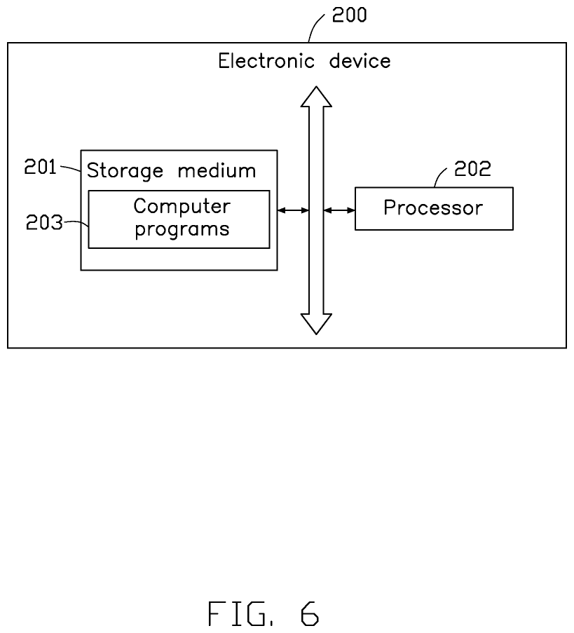

Referring to FIG. 6, FIG. 6 illustrates an electronic device 200. The electronic device 200 includes a storage medium 201, a processor 202, and computer programs 203. The computer programs 203 are stored in the storage medium 201, and are implemented by the processor 202.

The electronic device 200 can be a desktop computer, a notebook, a palmtop computer, or a cloud server. It will be understood by those skilled in the art that the schematic diagram is merely an example of the electronic device 200, and does not constitute a limitation of the electronic device 200. The electronic device 200 may include more or less components than those illustrated, and some components may be combined or be different. For example, the electronic device 200 may also include input and output devices, network access devices, buses, and the like.

The processor 202 is configured to execute the computer programs 203 to implement the blocks in the method, for example the block S1 to the block S7. The processor 202 is configured to execute the computer programs 203 to implement the function of the modules in the defect detection apparatus 100, for example, the training module 101, the image processing module 102, the comparing module 103, the confirming module 104, the obtaining module 105, and the prompting module 106.

The computer programs 203 can be partitioned into one or more modules that are stored in the storage medium 201 and executed by the processor 202. The one or more modules may be a series of computer program instruction segments capable of performing a particular function, the instruction segments being used to describe the execution of the computer programs 203 in the electronic device 200. For example, the computer program 203 can be divided into the training module 101, the image processing module 102, the comparing module 103, the confirming module 104, the obtaining module 105, and the prompting module 106 in the second embodiment.

The processor 202 can be a central processing unit (CPU), or may be other general-purpose processors, a digital signal processor (DSP), an application specific integrated circuit (ASIC), Field-Programmable Gate Array (FPGA) or other programmable logic devices, discrete gate or transistor logic device, discrete hardware components, or the like. The general-purpose processor may be a microprocessor or the processor 202 may be any conventional processor or the like. The processor 202 is a control center of the electronic device 200 and connects various parts of the entire electronic device 200 by using various interfaces and lines.

The storage medium 201 can be used to store the computer program 203 and/or modules. The processor 202 runs or executes or invokes the computer programs 203 and/or modules stored in the storage medium 201. The storage medium 201 may mainly include a storage program area and a storage data area, wherein the storage program area may store an operating system, an application required for at least one function (such as a sound playback function or an image displaying function), and the like. Data and the like created according to the use of the electronic device 200 are stored. In addition, the storage medium 201 may include a high-speed random access memory, and may also include a non-volatile memory such as a hard disk, a memory, a plug-in hard disk, a smart memory card (SMC), and a secure digital (SD) card, flash card, at least one disk storage device, flash device, or other volatile solid-state storage device.

The modules integrated by the electronic device 200 can be stored in a computer readable storage medium if implemented in the form of a software functional unit and sold or used as a standalone product, and can be stored in a computer readable storage medium. Based on such understanding, the present disclosure implements all or part of the processes in the foregoing embodiments, and may also be completed by a computer program to instruct related hardware. The computer program may be stored in a computer readable storage medium. The steps of the various method embodiments described above may be implemented when the program is executed by the processor. The computer program includes computer program code, which may be in the form of source code, object code form, executable file, or some intermediate form. The computer readable medium may include any entity or device capable of carrying the computer program code, a recording medium, a USB flash drive, a removable hard disk, a magnetic disk, an optical disk, a computer memory, a Read-Only Memory (ROM), Random access memory (RAM), electrical carrier signals, telecommunications signals, and software distribution media. It should be noted that the content contained in the computer readable medium may be appropriately increased or decreased according to the requirements of legislation and patent practice in a jurisdiction, for example, in some jurisdictions, according to legislation and patent practice, computer readable media does not include electrical carrier signals and telecommunication signals.

In the several embodiments provided by the present disclosure, it should be understood that the disclosed electronic device 200 and method may be implemented in other manner. The embodiments of the electronic device 200 described above are merely illustrative.

In addition, each functional unit in each embodiment of the present disclosure may be integrated in the same processing unit, or each unit may exist physically separately, or two or more units may be integrated in the same unit. The above integrated unit can be implemented in the form of hardware or in the form of hardware plus software function modules.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

While various and preferred embodiments have been described the disclosure is not limited thereto. On the contrary, various modifications and similar arrangements (as would be apparent to those skilled in the art) are also intended to be covered. Therefore, the scope of the appended claims should be accorded the broadest interpretation so as to encompass all such modifications and similar arrangements.

What is claimed is:

1. A method for detecting defects in images applicable in a defect detection apparatus; the defect detection apparatus comprising a processor and a storage with at least one command implementable by the processor to execute the following steps:
(a) inputting images of flaw-free products into an autoencoder (AE) for model training to obtain reconstructed images;
(b) processing the images of the flaw-free products to obtain target images;
(c) comparing the reconstructed images and the target images to obtain a group of testing errors;
(d) selecting an error threshold from the group of the testing errors based on a specified rule;
(e) obtaining a to-be-analyzed image and repeating the steps (a) to (c) to obtain a candidate be-analyzed reconstructed image, a candidate be-analyzed target image, and a potential be-analyzed error between the candidate be-analyzed reconstructed image and the candidate be-analyzed target image; and
(f) confirming a result of the to-be-analyzed image according to the potential be-analyzed error and the error threshold.

2. The method of claim 1, wherein the AE comprises an encoder and a decoder; the step (a) comprises:
extracting image features of the images of the flaw-free products by the encoder to output corresponding potential representation; and
decoding the potential representation by the decoder to obtain the reconstructed images.

3. The method of claim 1, wherein the step (b) further comprises:
processing the images of the flaw-free products by feature extraction functions to obtain textural features of each image of the flaw-free product; and
processing the textural features of each image of the flaw-free product to obtain the corresponding target image corresponding to each image of the flaw-free product.

4. The method of claim 3, wherein the feature extraction functions comprise a Gabor function and a gray-level co-occurrence matrix (GLCM) function; the textural features comprise a GLCM.

5. The method of claim 1, wherein each testing error is a square of pixel difference value between the reconstructed image and the corresponding target image; and each potential be-analyzed error is a square of pixel difference value between the candidate be-analyzed reconstructed image and the corresponding candidate be-analyzed target image.

6. The method of claim 1, wherein the error threshold is a maximum testing error in the group of the testing errors.

7. The method of claim 1, wherein the step (f) comprises:
when the potential be-analyzed error is less than the testing error, the result of to-be-analyzed image is taken as confirming that there is no defect revealed in the to-be-analyzed image; and
when the potential be-analyzed error is larger than or equal to the testing error, the result of to-be-analyzed image is confirmed that there is one or more defect exist and are revealed in the to-be-analyzed image.

8. A defect detection apparatus comprises a processor and a storage medium; the processor executes program codes stored in the storage medium; the storage medium comprises:
a training module, configured to input images of the flaw-free products into an autoencoder (AE) for model training to obtain reconstructed images;
an image processing module, configured to process the images of the flaw-free products to obtain corresponding target images;
a comparing module, configured to compare the reconstructed images and the target images to obtain a group of testing errors;
a confirming module, configured to select an error threshold from the group of the testing errors based on a specified rule; and
an obtaining module, configured to obtain a to-be-analyzed image and input the to-be-analyzed image to the training module to obtain a candidate be-analyzed reconstructed image;
the image processing module further processes the to-be-analyzed image to obtain a candidate be-analyzed target image; the comparing module further compares the candidate be-analyzed reconstructed image and the candidate be-analyzed target image to obtain a potential be-analyzed error; the confirming module further confirms the result of the to-be-analyzed image according to the potential be-analyzed error and the error threshold.

9. The defect detection apparatus of claim 8, wherein the AE comprises an encoder and a decoder; the training module further extracts image features of the images of the flaw-free products by the encoder to output corresponding potential representation; the training module further decodes the potential representation by the decoder to obtain the reconstructed images.

10. The defect detection apparatus of claim 8, wherein the image processing module further processes the images of the flaw-free products by feature extraction functions to obtain textural features of each image of the flaw-free product; the image processing module processes the textural features of each image of the flaw-free product to obtain the corresponding target image corresponding to each image of the flaw-free product.

11. The defect detection apparatus of claim 10, wherein the feature extraction functions comprise a Gabor function and a gray-level co-occurrence matrix (GLCM) function; the textural features comprise a GLCM.

12. The defect detection apparatus of claim 11, wherein when the potential be-analyzed error is less than the testing error, the confirming module confirms that there is no defect revealed in the to-be-analyzed image; when the potential be-analyzed error is larger than or equal to the testing error, the confirming module confirms that there is at least one defect in the to-be-analyzed image.

13. A computer readable storage medium, the computer readable storage medium stores at least one command; the at least one command is implemented by a processor to execute the following steps:
(a) inputting images of the flaw-free products into an autoencoder (AE) for model training to obtain corresponding reconstructed images;
(b) processing the images of the flaw-free products to obtain corresponding target images;
(c) comparing the reconstructed images and the target images to obtain a group of testing errors;
(d) selecting an error threshold from the group of the testing errors based on a specified rule;
(e) obtaining a to-be-analyzed image and repeating the steps (a) to (c) to obtain a candidate be-analyzed reconstructed image, a candidate be-analyzed target image, and a potential be-analyzed error between the candidate be-analyzed reconstructed image and the candidate be-analyzed target image; and
(f) confirming a result of the to-be-analyzed image according to the potential be-analyzed error and the error threshold.

14. The computer readable storage medium of claim 13, wherein the AE comprises an encoder and a decoder; the step (a) comprises:
extracting image features of the images of the flaw-free products by the encoder to output corresponding potential representation; and
decoding the potential representation by the decoder to obtain the reconstructed images.

15. The computer readable storage medium of claim 13, wherein the step (b) further comprises:
processing the images of the flaw-free products by feature extraction functions to obtain textural features of each image of the flaw-free product; and
processing the textural features of each image of the flaw-free product to obtain the corresponding target image corresponding to each image of the flaw-free product.

16. The computer readable storage medium of claim 15, wherein the feature extraction functions comprise a Gabor function and a gray-level co-occurrence matrix (GLCM) function; the textural features comprise a GLCM.

17. The computer readable storage medium of claim 13, wherein each testing error is a square of pixel difference value between the reconstructed image and the corresponding target image; and each potential be-analyzed error is a square of pixel difference value between the candidate be-analyzed reconstructed image and the corresponding candidate be-analyzed target image.

18. The computer readable storage medium of claim 13, wherein the error threshold is a maximum testing error in the group of the testing errors.

19. The computer readable storage medium of claim 13, wherein the step (f) comprises:
when the potential be-analyzed error is less than the testing error, the result of to-be-analyzed image is taken as confirming that there is no defect revealed in the to-be-analyzed image; and
when the potential be-analyzed error is larger than or equal to the testing error, the result of to-be-analyzed image is taken as confirming that there is one or more defect exist and are revealed in the to-be-analyzed image.
